(19) United States
(12) Patent Application Publication
(10) Pub. No.: US 2010/0153685 A1
(43) Pub. Date: Jun. 17, 2010

(54) Multiprocessor system

(75) Inventor: Sami Yehia, Boulogne Billancourt (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/622,674

(22) Filed: Nov. 20, 2009

(30) Foreign Application Priority Data
Nov. 21, 2008 (FR) 08 06552

(51) Int. Cl. G06F 15/76; G06F 9/02

(52) U.S. Cl. 712/29; 712/E09.002

(57) ABSTRACT

The invention relates to a multiprocessor system on an electronic chip (300) comprising at least two computing tiles, each of the computing tiles comprising a generalist processor, and means for access to a communication network (320), the said computing tiles being connected together via the said communication network, the said multiprocessor system being characterized in that:
a generalist processor using an instruction set which defines all the operations to be executed by the said processor, the generalist processors have one and the same instruction set;
at least one of the computing tiles also comprises an accelerator coupled to the generalist processor accelerating computing tasks of the said generalist processor.

The invention relates to onboard architectures and more precisely parallel architectures on an electronic chip.

The requirements of the military and civil industry in computing terms have not ceased to grow in recent years. These requirements are mostly expressed in the field of onboard systems notably concerning signal and image processing. They are also characterized by tight, sometimes contradictory, constraints of energy consumption, high performance and real time processing.

In order to respond to these tight constraints, both in onboard systems and in high-performance systems, and following the rise in frequency of new integration technologies, two channels of additional research have appeared: parallelism and specialization. Parallelism consists in simultaneously carrying out various computing tasks on various processors. Architectures dedicated to parallelism, called parallel architectures, consist of several computing units, called computing tiles, connected together via a communication network. A tile usually comprises a processor and means for dialogue with the communication network.

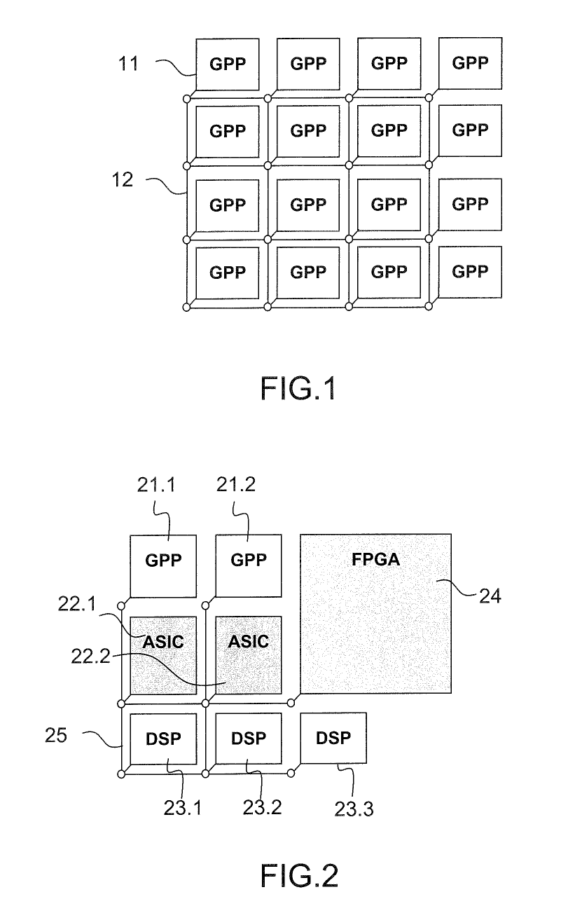

In most parallel architectures according to the prior art, parallelism is based on identical tiles called homogeneous tiles. FIG. 1 represents an example of homogeneous parallel architecture. This architecture comprises sixteen tiles of generalist processors 11 connected together via a communication network 12. The Quad core microprocessor from Intel and the Tile64 microprocessor from Tilera are two examples of such architectures.

In this model, the computing tiles are identical; they have the same instruction set and the same architecture. The instruction set of a processor is all the operations that this processor can execute. The instruction set directly influences the way of programming an on-processor process. Therefore the programming model does not differentiate between them. That is to say that the role of the programmer (or an automatic parallelizer) is to describe the parallelism without having to describe in which tile each task will be executed.

According to the prior art, a variant of homogeneous parallel architecture consists in associating a master processor with identical accelerators. The cell processor from IBM is an example of such an architecture.

According to the prior art, in the field of onboard systems, specialization of computing by using specialized units and accelerators is used to satisfy performance and energy consumption requirements. Unlike processors called “generalist” processors (which are capable of executing a broad spectrum of applications), accelerators are dedicated and optimized to accelerate various tasks such as video, communication functions or image processing. Parallel architectures incorporating such specialized circuits are called heterogeneous parallel architectures. FIG. 2 represents an example of heterogeneous parallel architecture. This architecture comprises, on the one hand, tiles of generalist processors 21.1, 21.2 and, on the other hand, tiles of specialized processors: three specialized circuits 23.1, 23.2, 23.3 in signal processing of the DSP type (for Digital Signal Processor), two dedicated circuits of the ASIC (Application-Specific Integrated Circuit) type 22.1, 22.2 and a reconfigurable circuit 24 of the FPGA (Field-Programmable Gate Array) type. These tiles are connected together via a communication network 25. The Nomadik system from ST is an example of such an architecture.

A heterogeneous architecture consists of a multitude of heterogeneous tiles. Some of these tiles arc generalist processors, others are dedicated accelerators which may or may not be programmable. The heterogeneous dedicated accelerators allow increased efficiency in terms of performance and consumption. However, in these architectures, the programming model is more complex. The programmer must explicitly describe the correspondence between the tasks and each of the different tiles of the architecture. The compilation chain must also take account of different instruction sets, modes of execution and heterogeneous interfaces, which complicates it substantially.

The RECORE architecture is another example of a heterogeneous architecture. This architecture combines a generalist processor, called a “master” processor and heterogeneous tiles. In this approach, the accelerators are fixed during the design of the architecture and the parallelization (the programming model) depends on these accelerators. The disadvantage of this is that it induces a high degree of correlation between the parallelization and the target architecture.

The object of the invention is to alleviate the aforementioned problems by proposing a multiprocessor system offering improved computing capabilities while retaining ease of programming.

Accordingly, the subject of the invention is a multiprocessor system on an electronic chip comprising at least two computing tiles, each of the computing tiles comprising a generalist processor, and means for access to a communication network, the said computing tiles being connected together via the said communication network, the said multiprocessor system being characterized in that:
a generalist processor using an instruction set which defines all the operations to be executed by the said processor, the generalist processors have one and the same instruction set;
at least one of the computing tiles also comprises an accelerator coupled to the generalist processor accelerating computing tasks of the said generalist processor.

According to one feature of the invention, the system is capable of executing a parallel program developed for a homogeneous multiprocessor system with no program modification.

According to one feature of the invention, a computing tile also comprises a local memory.

According to one feature of the invention, since the system comprises a main memory, a computing tile also comprises a device for direct access to the memory allowing the transfer of data between the main memory and the local memory.

According to one feature of the invention, the accelerator is of one of the following types: dedicated integrated circuit, programmable accelerator, for example a circuit specializing in signal processing, or reconfigurable circuit.

According to one feature of the invention, the main memory is physically shared between the tiles, each tile being able to access the said main memory.

According to one feature of the invention, the main memory is physically distributed between the various tiles, each tile then comprising a portion of the main memory.

According to one feature of the invention, the communication network is of one of the following types: simple bus, segmented bus, loop or network-on-chip.

A first advantage of the system according to the invention is that it is characterized by a homogeneous and generalist interface (like the homogeneous multi-tile architectures) relative to the programming model while retaining diversity inside the tiles of the chip. This homogeneous and generalist interface, obtained by using generalist processors having the same instruction set, offers a programming model that is simpler than that of the heterogeneous architectures according to the prior art. The diversity inside the tiles has the effect of increasing computing performance relative to the homogeneous architectures according to the prior art.

By using the invention, a program is parallelized as if all the computing tiles were generalist processors. Each portion of parallelized program is then assigned to a computing tile according notably to its match with the accelerator of this tile or, in the worst case, to a generalist processor of one of the tiles like a homogeneous multi-tile. The invention therefore guarantees perfect compatibility with homogeneous multicore architectures.

This regular interface is expressed, on the one hand, by a generalist processor on each tile with a common architecture seen by the programming model and, on the other hand, an interface between each generalist processor and the accelerator attached to the latter and, further, a coherent and regular programming model. The advantage of this is that it reduces the development cost of the applications and makes it possible to reuse the programming tools of homogeneous parallel architectures that already exist.

Another advantage of the system according to the invention is that it also makes it possible to use programming models that already exist for homogeneous parallel architectures. It is therefore possible to execute directly on a system according to the invention an application which has not been designed directly for the latter.

The invention will be better understood and other advantages will appear on reading the detailed description given as a non-limiting example and with the aid of the figures amongst which:

FIG. 1, already described, shows an example of homogeneous parallel architecture.

FIG. 2, already described, represents an example of heterogeneous parallel architecture.

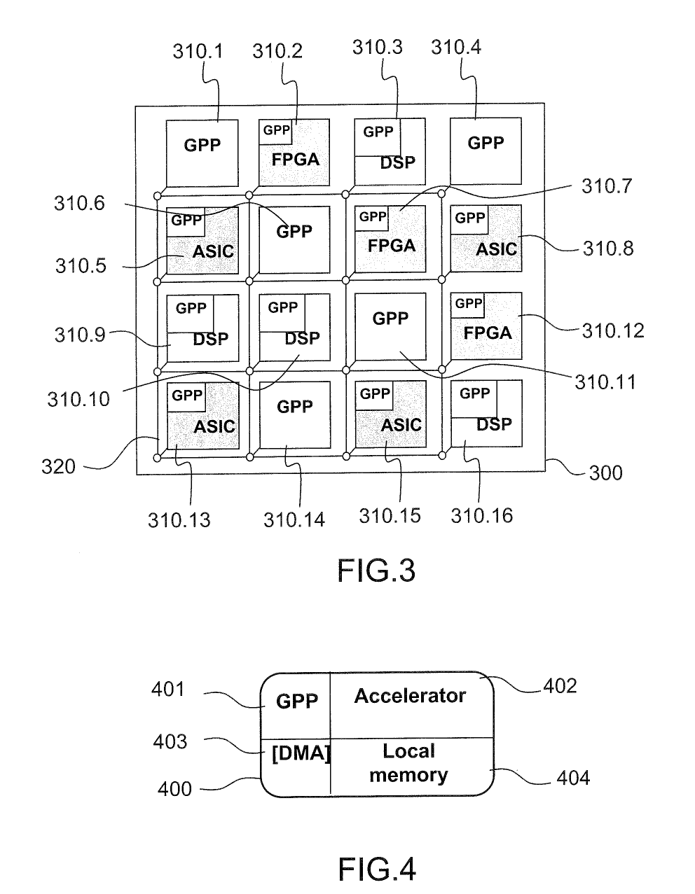

FIG. 3 represents an example of parallel architecture according to the invention.

FIG. 4 represents an example of a computing tile in an architecture according to the invention.

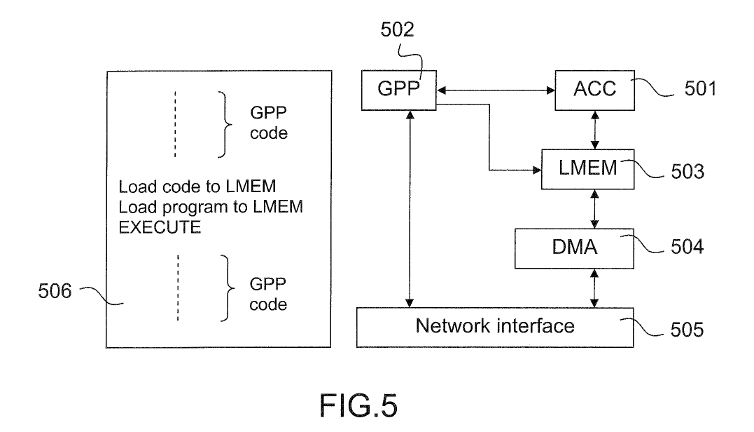

FIG. 5 shows an example of a weakly-coupled accelerator and an associated software interface.

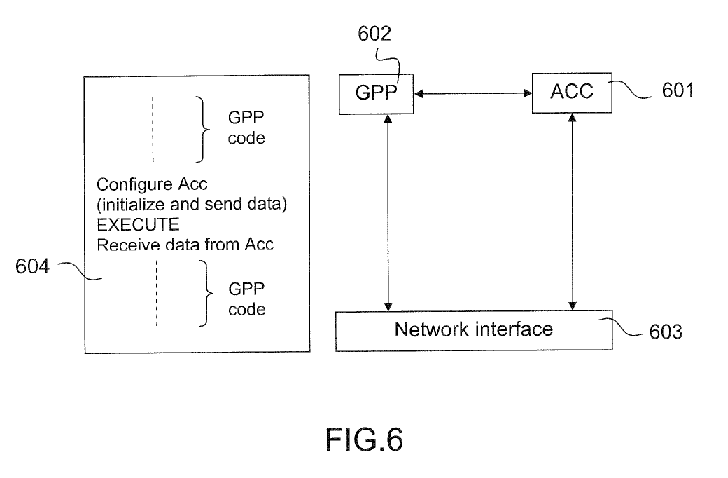

FIG. 6 shows an example of an averagely-coupled accelerator and an associated software interface.

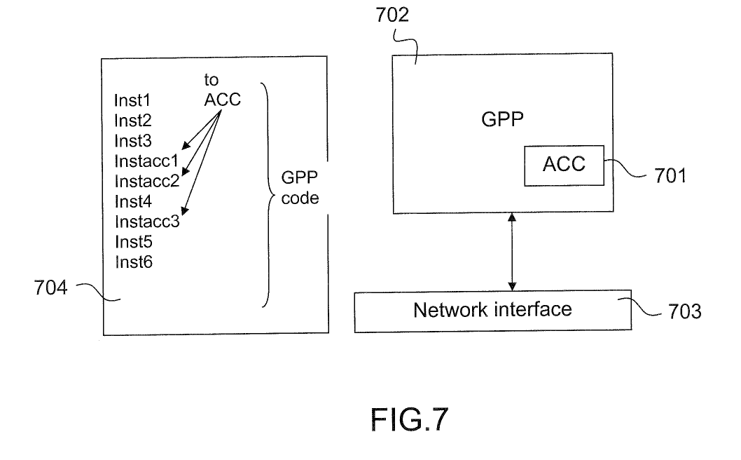

FIG. 7 shows an example of a strongly-coupled accelerator and an associated software interface.

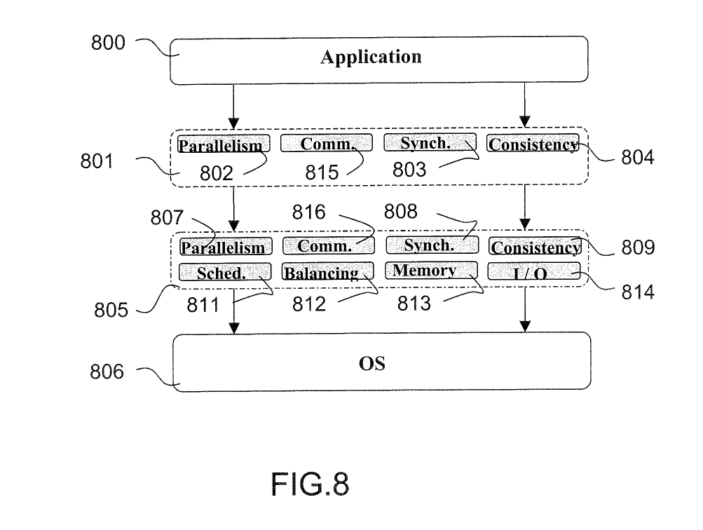

FIG. 8 represents an execution model according to the prior art.

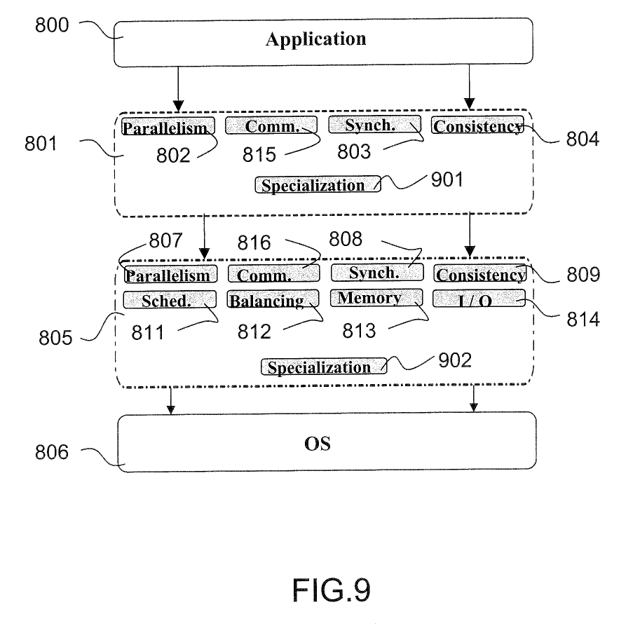

FIG. 9 shows an example of an execution model according to the invention.

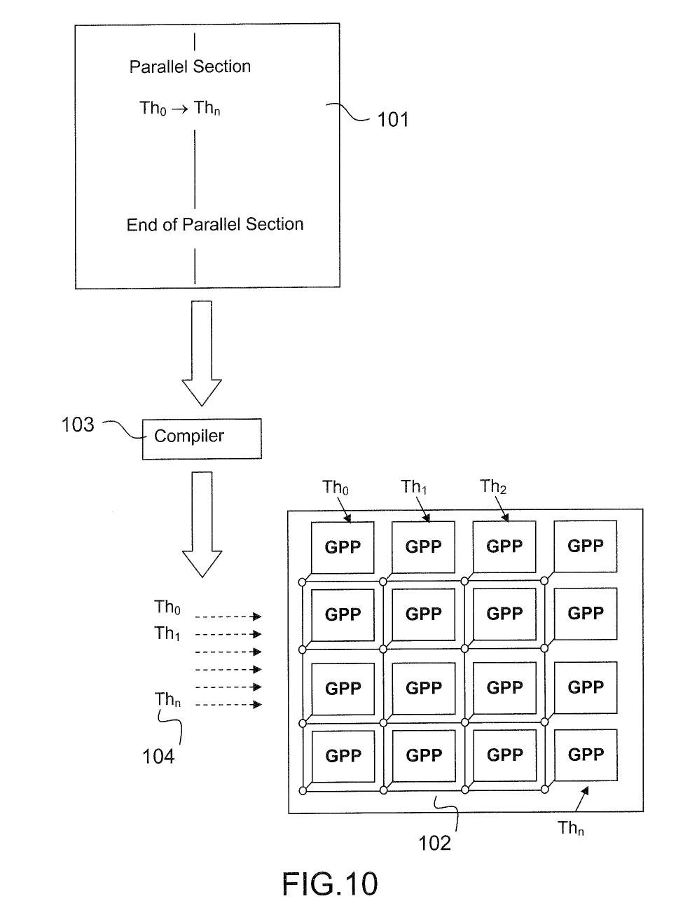

FIG. 10 shows an example of the execution of a parallel program on a homogeneous architecture with no accelerator.

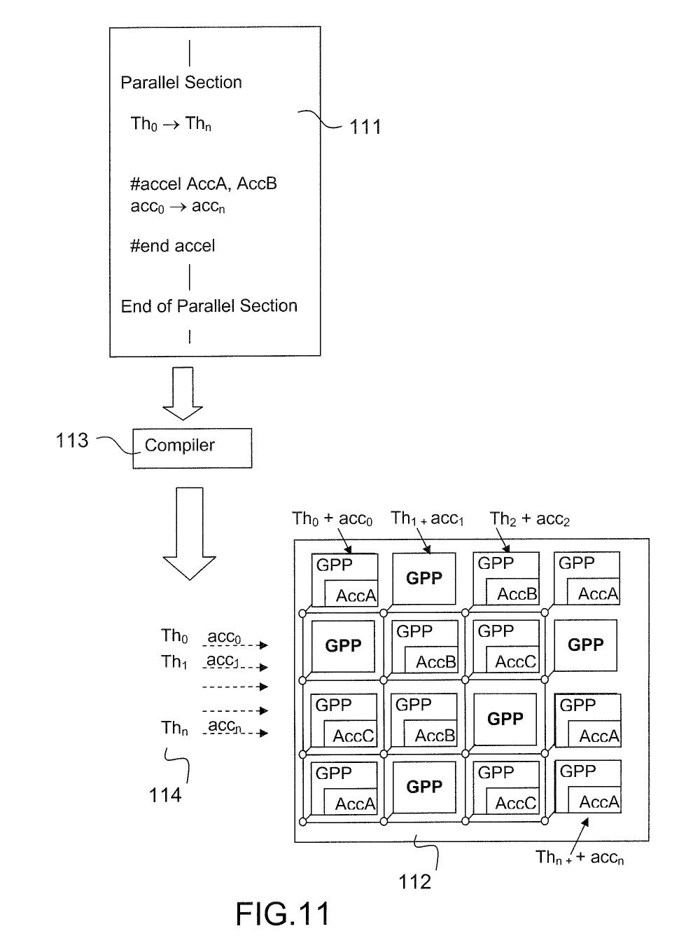

FIG. 11 shows an example of deployment of a parallel program on an architecture according to the invention.

FIG. 3 represents an example of parallel architecture according to the invention. The parallel architecture of the example comprises sixteen computing tiles placed on an electronic chip 300. These computing tiles are connected together via a communication network 320.

The architecture according to the invention comprises a homogeneous mesh of tiles in which each tile comprises a generalist processor optionally coupled to a dedicated accelerator. In the example of the figure, five tiles 310.1, 310.4, 310.6, 310.11, 310.14 comprise a single generalist processor GPP, four tiles 310.3, 310.9, 310.10, 310.16 comprise a generalist processor GPP and a circuit specialized in the processing of the signal DSP, four tiles 310.5, 310.8, 310.13, 310.15 comprise a generalist processor GPP and an application-specific integrated circuit ASIC and three tiles 310.2, 310.7, 310.12 comprise a generalist processor GPP and a reconfigurable circuit FPGA.

The presence of a generalist processor with an instruction set and a single architecture on all the tiles allows the programming model to have a homogeneous view over all the tiles and to use the already existing parallel programming techniques on a homogeneous tile architecture. The generalist processor is more or less powerful depending upon the requirements and upon the role of the accelerator coupled to the latter. For example, a complex video accelerator may be content with a small generalist processor playing only the role of a controller which orchestrates the memory access and the communications of the accelerator. At the other extreme, a tile may consist of a very powerful processor supporting, for example, a floating computing or highly-coupled or superscalar SIMD allowing a parallel execution of the instructions.

This variation of the generalist processor does not contradict the hypothesis of a single instruction set, an architecture and a single interface: most manufacturers of known processors, notably in the field of onboard systems, offer a wide range of processors that range from a microcontroller to high-performance processors and obey the same architecture. For example, the Cortex family from ARM offers three ranges of processors, the M range for microcontrollers, R in the middle of the range and A for aggressive top-of-the-range processors. Similarly, the MIPS family is equipped with a family ranging from M4K (0.3 mm² on a 0.13u technology) to the 20Kc (8 mm² on the same technology).

Therefore, an architecture according to the invention can, for example, comprise several types of tiles. The accelerators attached to the dedicated processors may take the form of an SIMD programmable accelerator, an FPGA, a dedicated ASIC accelerator or any other accelerators.

In order to offer uniformity from the point of view of the programming model despite the heterogeneity of the tiles of the architecture, it is necessary to define a common view of each tile or basic brick.

FIG. 4 represents an example of a computing tile in an architecture according to the invention. Such a tile 400 comprises: a generalist processor 401, a specialized computing element, also called an accelerator 402, and a local memory 404. The generalist processor is the basis of the tile. The architecture of the generalist processor provides the standard interfaces in order to configure the accelerator, send it the data and launch execution. The specialized computing element 402 implements the main function of the brick, for example SIMD or dedicated Accelerator. The local memory 404 may take the form of a cache or a temporary memory (or scratchpad) depending on the nature and the requirements of the accelerator 402.

According to a variant of the invention, a tile also comprises a device for direct access to the memory 403 or DMA, the acronym for “Direct Memory Access”. The DMA 403 allows the transfer of data between a main memory, not shown, and the local memory 404. The DMA 403 can be used when the tile 400 comprises an accelerator 402 and when the latter is not strongly coupled to the generalist processor 401.

The interface between a generalist processor and an accelerator is divided into a hardware interface between the processor and the accelerator and a software interface which defines how the processor interacts with the accelerator. This interface depends on the type of coupling between the processor and the accelerator. It is possible to define three types of coupling: weakly coupled, averagely coupled and strongly coupled.

FIG. 5 shows an example of a weakly-coupled accelerator. In this type of coupling, the accelerator 501 independently executes the generalist processor 502 and its object is mainly to accelerate important tasks, called large-grain tasks, requiring no interaction with the processor 502. The granularity of a task is the minimum size of a computing task that can be manipulated by an accelerator. The accelerator 501 and the generalist processor 502 have access to a local memory 503 having access to a network interface 505 via a device for direct access to the memory 504. A software interface 506 describes that the processor 502 initiates access to the memory 503 (load code to LMEM and load program to LMEM), the accelerator 501 of which needs and launches execution of the accelerator 501 (EXECUTE).

FIG. 6 shows an example of an averagely-coupled accelerator. In this type of interface, the accelerator 601 interacts directly with the processor 602 during execution, so these two can communicate data during execution. The accelerator also has access to the external memory or to the external network 603. Note that the difference between weak coupling and average coupling lies mainly in the granularity of the task carried out by the accelerator and nothing prevents a combination of the two (interaction with GPP and local memory). The main difference between the software interface 604 of an averagely-coupled accelerator and the above software interface 506 is the absence of local memory or of DMA transfer. Specifically, the accelerator of FIG. 6 is a special case of that of FIG. 5 where the communications are carried out between the processor and the accelerator.

FIG. 7 shows an example of a strongly-coupled accelerator. This type of accelerator accomplishes relatively fine-grained tasks like the SIMD accelerators that exist on the market. Usually, the accelerator 701 is situated at the same level as the main computing unit of the processor 702 and interfaces directly with the register bank. The accelerator may also have access to the memory. In this case, the software interface comprises more or less complex instructions directly addressed to the accelerator. The processor 702 is connected to a network interface 703.

The architecture according to the invention may assume several memory models. The main memory may be physically shared between the tiles. In this case, the local memories are considered to be caches or temporary memories managed by the programming model. Additionally, the memory may be physically distributed between the various tiles, each tile then comprising a portion of the main memory. Moreover, the main memory may be logically distributed, each tile being able to see and to address only a single portion of the main memory or else the memory has a single address space (logically shared), each tile then being able to access the whole of the main memory.

As in parallel architectures according to the prior art, the interconnection network may be a simple bus, a segmented bus, a loop, or a network-on-chip (NoC).

FIG. 8 shows a model of execution according to the prior art adapted to a conventional parallel architecture. The user describes (more or less, according to the programming model) the parallelism of an application 800 with the aid of primitives (or library calls) supplied by the programming model 801. These primitives may be primitives which define the parallelism 802 (for example defining the loops the iterations of which can be executed in parallel, or defining parallel tasks), communication primitives 815 (transmission or reception of data), or synchronization 803 (execution barrier for example). The programming model also defines the memory consistency model 804. The execution system 805 (or “runtime system”) forms the intermediate layer between the programming model 801 and the operating system 806 and transmits the appropriate system calls to the operating system. The execution system 805 may have a more or less important role depending on the power and functionalities of the programming model 801. It is possible to cite amongst its possible roles: detection and automation of the parallelism 807, the implementation of the communications 816, synchronization 808, memory consistency 809, scheduling 811 and balancing 812 of the tasks, management of the memory 813 and input/output managements 814.

FIG. 9 shows an example of an execution model according to the invention adapted to the system according to the invention. The execution model according to the invention adopts the characteristics of the execution model according to the prior art. But it differs from the latter in that it also comprises a first specialization layer 901 added to the programming model 801 and a second specialization layer 902 added to the execution system 805. The specialization layers may be more or less important depending on their functionalities.

Described below is a minimal execution model in which the specialization is set out by the programmer with a second layer of specialization 902 added to the execution system 805.

Associating a generalist processor with an accelerator allows at least perfect compatibility with the homogeneous multicore applications. An application targeting a homogeneous multicore architecture can be compiled and executed on the architecture according to the invention with no modification supposing that the memory and networks architecture are identical. The acceleration aspect therefore occurs after parallelization, unlike the current approaches in which the specialization forms an integral part of the development of the application which limits the portability of the application and therefore increases the development costs. Thanks to the regular interface between the generalist processors and the accelerators, each execution thread can be accelerated according to the existing accelerators and the needs of the application without changing the way in which the application has been parallelized. In the simplest form of the invention, the programmer delimits the portions to be accelerated after parallelization of the application.

FIG. 10 shows an example of the execution of a parallel program 101 on a homogeneous architecture 102, without an accelerator and comprising sixteen generalist processors GPP. In this example, the programmer defines the parallelism by delimiting a parallel section (for example a loop the iterations of which are executed in parallel or parallel tasks) with the aid of specific instructions: parallel section/end of parallel section. The compiler 103 or the parallelization library concern themselves with converting this portion of the code into different threads 104 of parallel execution (th0 to thn) which are executed in parallel on the parallel processors.

FIG. 11 shows an example of deployment of a parallel program 111 on an architecture according to the invention 112 in which each accelerator is associated with a generalist processor. According to a variant application, the programmer delimits the portions to be accelerated within the parallel section, by specifying on which type of accelerator these sections to be accelerated may be deployed. In the example, a portion of the parallel section is delimited (#Accel/#end Accel). Two types of accelerators Acc A and Acc B are specified as a possible acceleration target. The generalist processor is still implicitly a possible target. Depending on the available resources, the compiler 113 generates the code necessary for the generalist processors and each of the target accelerators. Each execution thread 114 is executed either on the generalist processor only or on a generalist processor and one of the specified target accelerators. If an accelerator is not specified in the list of possible target accelerators (such as Acc C in the example), the execution thread is executed only on the generalist processor.

The specialization may be static or dynamic. With static specialization, the specialization and assignment of the tasks to the accelerators are carried out statically during the compilation, and the runtime assigns each specialized task to the corresponding accelerator according to the distribution specified by the compiler or the associated library.

With dynamic specialization, the specialization and assignment of the tasks to the accelerators are carried out dynamically by the runtime during execution according to the availability of the resources during execution. A dynamic specialization allows a better adaptation of the execution of the application depending on the availability of the resources and other dynamic constraints but implies a greater complexity of the runtime specialization layer.

In order to preserve the homogeneity of the architecture in the programming model, the programmer may, for example, describe the application in the same way as for a parallel architecture by also indicating the possibilities for assigning tasks to types of accelerators.

1. Multiprocessor system on an electronic chip (300) comprising at least two computing tiles, each of the computing tiles comprising a generalist processor, and means for access to a communication network (320), the said computing tiles being connected together via the said communication network, the said multiprocessor system being characterized in that:
a generalist processor using an instruction set which defines all the operations to be executed by the said processor, the generalist processors have one and the same instruction set;
at least one of the computing tiles also comprises an accelerator coupled to the generalist processor accelerating computing tasks of the said generalist processor.

2. Multiprocessor system according to claim 1, characterized in that it is capable of executing a parallel program developed for a homogeneous multiprocessor system with no program modification.

3. Multiprocessor system according to one of claims 1 and 2, characterized in that a computing tile (400) also comprises a local memory (404).

4. Multiprocessor system according to claim 3, characterized in that, since the system comprises a main memory, a computing tile (400) also comprises a device for direct access to the memory (403) allowing the transfer of data between the main memory and the local memory (404).

5. Multiprocessor system according to one of claims 1 to 4, characterized in that the accelerator is of one of the following types: dedicated integrated circuit, programmable accelerator, reconfigurable circuit.

6. Multiprocessor system according to one of claims 3 to 5, characterized in that the main memory is physically shared between the tiles, each tile being able to access the said main memory.

7. Multiprocessor system according to one of claims 3 to 5, characterized in that the main memory is physically distributed between the various tiles, each tile then comprising a portion of the main memory.

8. Multiprocessor system according to one of the preceding claims, characterized in that the communication network is of one of the following types: simple bus, segmented bus, loop or network-on-chip.
